(19) United States
(12) Patent Application Publication
(10) Pub. No.: US 2020/0321765 A1
(43) Pub. Date: Oct. 8, 2020

(54) Mast Arm Condulet

(71) Applicant: Cody Paul Laursen, Fresno, CA (US)

(72) Inventor: Cody Paul Laursen, Fresno, CA (US)

(21) Appl. No.: 16/374,754

(22) Filed: Apr. 4, 2019

(51) Int. Cl. H02G 7/20

(52) U.S. Cl. CPC H02G 7/20; G08G 1/095

(57) ABSTRACT

The present invention discloses a traffic signal terminal compartment which slips directly onto a tenon. The terminal compartment has two 1-½″ NPT holes for attaching signal frameworks of different varieties. It proposes a new system for mounting traffic signal lights to a mast arm where the terminal compartment slips onto the tenon on the mast arm. It makes assembly and installation of traffic lights much faster and easier and is more versatile than the standard MAS or MAT mountings that have historically been used.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark: Office patent files or records, but otherwise reserves all copyright rights whatsoever.

### BACKGROUND

### Field of the Invention

This invention relates to traffic signal hardware and more particularly relates to a first of type traffic signal terminal compartment which slips directly onto a tenon. The terminal compartment has two 1½″ NPT holes for attaching signal frameworks of different varieties.

### Description of the Related Art

Traffic signal lights have been around for years and are used to efficiently control traffic through intersections. While traffic signals have been around for years, improvements continue to be made in the areas of traffic signal light control algorithms, traffic volume detection, and emergency vehicle detection.

There are many inventions that have been found in prior art regarding traffic signal advancements. For instance, Traffic signal installation comprising an led-light source bearing U.S. Pat. No. 6,858,994B2 is issued to Sickinger Monika. The traffic signal installation with an LEI) light source (2), comprising: an input (38, 40) for connection of a current source; furthermore, at potential levels between the upper potential (16) and the base potential (18): a plurality of LEDs (4) arranged in at least two series connections of several LEDs that are connected in parallel; a coil (6) provided in series with the LEDs (4); a recovery diode (8) provided in parallel to the LEDs (4) and the coil (6) and having its forward direction opposed to that of the LEDs (4); and a rapid electronic switch (10) provided in series with the LEDs (4), the coil (6) and the recovery diode (8) in parallel to the LEDs (4) and the coil (6); and a pulse generator (12) that is connected to the rapid electronic switch (12) and generates pulses that open and close the rapid electronic switch (10), said pulse generator (12) being a pulse-width modulator in particular in the form of an integrated component.

A Traffic signal light having ambient light detection bearing U.S. Pat. No. 7,088,261B2 is issued to Light Vision Systems Inc , Optisoft Inc. The patent discloses a traffic signal (310) having a reflector (322, 400) having a plurality of reflective surfaces (330, 402) directing incident ambient light received from the signal lens (318) to a photodetector (322). The reflector is disposed proximate and about a plurality of LEDs (324, 406) which are pulse width modulated by an integrated controller (360) to generate light which is also transmitted through the lens. The photodetector senses the incoming ambient light when the LEDs are in the “off” mode. Incident ambient light is focused by a lens to overfill the reflector and LEDs, and the photodetector is positioned within the redirected incident ambient light from the lens.

A Traffic signal preemption system bearing Canadian patent 1,338,356C is issued to Rodney Kris Morgan, Bradley Kent Cross. When placed into operation by the occupants of an emergency vehicle, a vehicle transmission system having a directional antenna sends out a series of UHF messages spaced apart by varying lengths of time and identifying the emergency vehicle, its priority, and its direction, or indicating that the vehicle is travelling along a pre-planned route. At each signal-controlled intersection, a vehicle detection, identification, and preemption system having an omnidirectional antenna and containing information identifying vehicles authorized to preempt the intersection and their pre-planned directions of travel receives these messages from plural vehicles and determines when and in favor of which direction and for how long the intersection is to be preempted.

A Traffic control system using light emitting diodes bearing Candian patent CA2,169,037C is issued to Peter A. Hochstein. The patent discloses a traffic control system (10) including a road (12), a vehicle (14) traveling on the road (12) and a traffic light assembly (16) operatively associated with the road (12) is disclosed. The traffic light assembly (16) comprises at least one traffic light or lamp means (18). The traffic light (18) includes a plurality of light emitting diodes (24) for projecting light rays to the vehicle (14) to provide the driver of the vehicle (14) with a visual signal. The system (10) further comprises a transmitter (20) including a power supply (30) and a modulator (72) for turning the diodes (24) on and off at a rate that is imperceivable to humans while optically transmitting information to a receiver (22) disposed on the vehicle (14).

A Temporary traffic light and signal system bearing European patent 0,462,832A2 is issued to Nikken Corp, The patent discloses a temporary signal system wherein a pair of signal stands (1) are installed at spaced locations adjacent a traffic restriction area. Each stand has at least red and green lights which light or flash for predetermined time periods to control vehicle traffic passing the restriction area. The signal stands (1) include timers (27) for counting actual time and providing the actual time, controllers (26) for producing a flashing control signal for a selected red or green light upon reception of a time signal provided by the timer when the controller is in a flashing operation condition, and a lighting driver (32, 33, 34) for permitting the selected red or green light to flash upon reception of the flashing control signal from the controller. The stands have an operation starting arrangement (19; 51, 52; 54, 60; 70, 75; 90, 95) for initiating operation of the controllers of both of the stands (1) at the same time, or a signal transmission arrangement (150, 190) for transmitting the operating condition data between the stands (111, 131) so that the lights of both stands are operated in a controlled and synchronized relationship with each other.

A Portable traffic signal light bearing U.S. Pat. No. 3,995,250A is issued to Robert W. Ferree. The patent discloses a portable apparatus providing for a temporary installation of a traffic control signal meeting the visual display requirements as specified by government authorities for standard traffic control lights. The apparatus includes a standard which is adapted to support the traffic signal heads at proper positions, both alongside the roadway and in an elevated position above the roadway, a control box for controlling the operation of the signal either in accordance with a pre-set program or in accordance with signals generated automatically or manually in response to traffic flow, a base element having means to anchor the unit firmly in place and to hold the vertical mast, the vertical mast with means for mounting the signal head at a proper elevation alongside the roadway, and a mast arm or boom pivotally attached adjacent to the upper end of the mast so that the boom can be readily positioned in a substantially horizontal alignment above the roadway and means to securely anchor the boom in the horizontal position, the boom also having means for mounting a signal head. The apparatus is designed to be carried and erected with a minimum effort. The base may be a separate piece, or a fitting firmly attached to a vehicle, or a semi-permanent installation attached to the ground. The vertical mast is releasably engageable with the base, said mast and base having cooperable elements facilitating erection and locking of the mast in a vertical position. An improved traffic control signal section is in the form of a lens assembly which combines the functions of the traditional housing and reflector in one piece to reduce the weight and cost of the assembly, the construction permitting ready maintenance of the system.

From the author detailed study, it has been concluded that there are numerous solutions that have been presented in prior art regarding presenting traffic signal installation system. Prior systems for controlling traffic through the use of traffic signal lights have involved either equipment which does not meet present continuous requirements standards, or considerable expense in the erection and maintenance of a control system primarily designed for permanent installations.

The current system proposes a new system for mounting traffic signal lights to a mast arm (the horizontal arm that goes over the street). It is a terminal compartment that slips onto the tenon on the mast arm. The current invention proposes to makes an assembly and installation of traffic lights much faster and easier and is more versatile than the standard MAS or MAT mountings that have historically been used.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The objective of the invention is to provide a terminal compartment which mounts directly to a mast arm tenon.

More specifically, it is the principal object of this invention to provide an assembly which slips directly onto a tenon. The terminal compartment has two 1½″ NPT holes for attaching signal frameworks of different varieties.

The object of the invention is also to provide an assembly which has main body of the MAC is made from sand casting and can be made from brass, iron, or aluminum

According to another aspect of the invention, it is also the objective of the invention to provide the door is made from cast aluminum, The castings are drilled and tapped to accept various types of hardware.

It is also a feature of the invention to provide an assembly which is easy to install and highly effective to use.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is an illustration of front view of assembly as per exemplary embodiments of the invention.

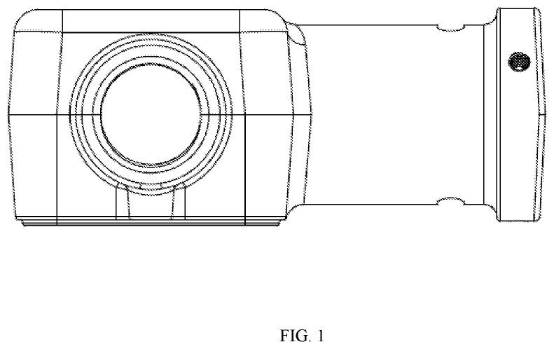

FIG. 2 is another front view of assembly consistent with the exemplary embodiments of the present invention.

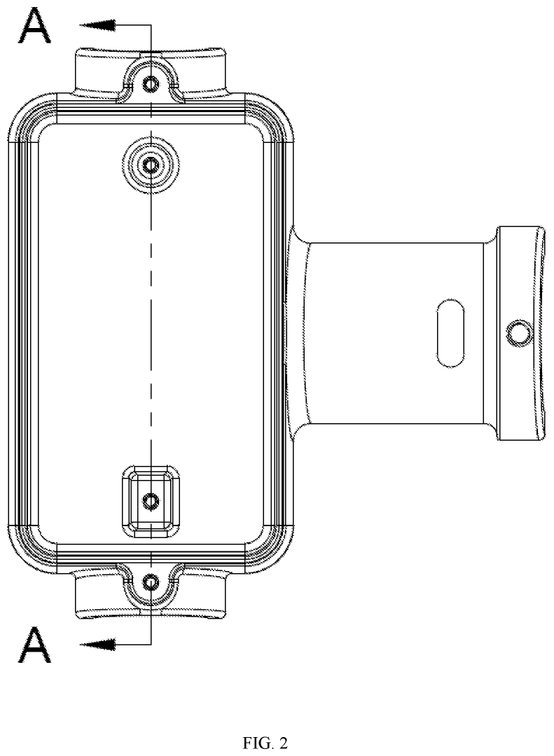

FIG. 3 is complete view showing the main assembly consistent with the exemplary embodiments of the present invention.

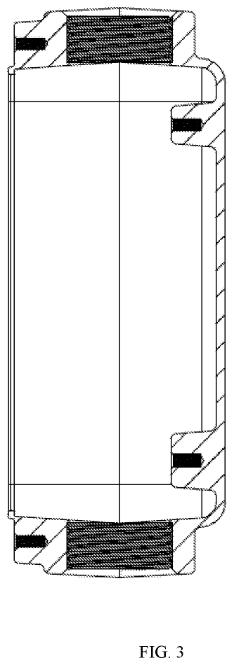

FIG. 4 is a cross sectional view of assembly, consistent with the exemplary embodiments of the present invention.

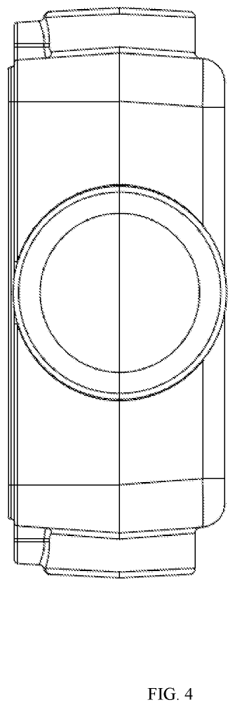

FIG. 5 is a back view showing the back and lateral view of main assembly consistent with the exemplary embodiments of the present invention.

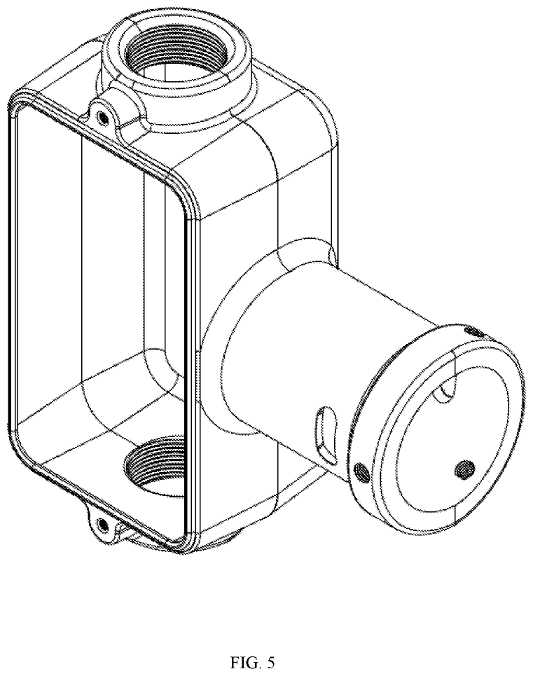

FIG. 6 is another view showing the main assembly consistent with the exemplary embodiments of the present invention.

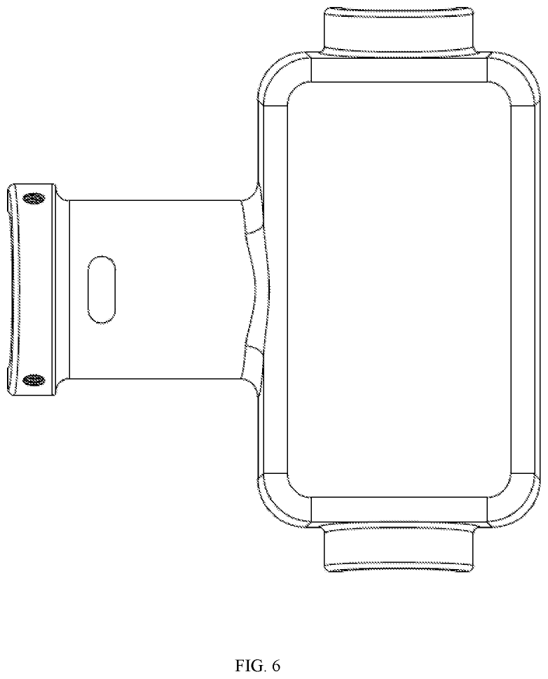

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a traffic signal terminal compartment which slips directly onto a tenon. The terminal compartment has two 1½″ NPT holes for attaching signal frameworks of different varieties.

The Mast Arm Condulet (or MAC) assembly as per its preferred embodiment is a terminal compartment with a slip fitter on the side into which a tenon will fit. The slip fitter is drilled and tapped to accommodate three, ⅜″ set screws which are tightened to retain the MAC onto the tenon.

The assembly as per its further embodiment has a slot cast through the slip fitter which is used for mounting a ⅜″ “safety bolt”. The safety bolt is inserted through the slot, a drilled hole in the tenon, and through the slot on the opposite side. This slot is used to retain the MAC assembly on the tenon in case of set screw failure.

The interior of the MAC main body as per its additional embodiment has 2 raised bosses, drilled and tapped #10-32, to attach a terminal block. The opening is also drilled and tapped for two #10-32 screws for mounting the compartment door. The MAC main body has openings on the top and bottom which are tapped for 1½″ NPT pipe fittings. These holes are used to attach various length pipe nipples and fittings to accommodate different configurations of traffic signal lights and railroad lights.

The terminal compartment which mounts directly to a mast arm tenon has the main body of the MAC made from sand casting and can be made from brass, iron, or aluminum. The door is made from cast aluminum. The castings are drilled and tapped to accept various types of hardware.

As per its proposed use, a service technician can install the traffic signal lights in whatever configuration desired onto the MAC on the ground/shop before installation onto the pole. After placing the lights in the desired configuration onto the MAC, all of the lights can be wired into the supplied terminal block. To install the whole assembly onto the mast arm, slip the tenon into the slip fitter while running the wires through the slip fitter, tighten the set screws, and install the safety bolt. Ensure lights are aligned and spaced according to local requirements. Finally, the wires are attached from the pole into the correct terminals in the terminal block.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A Traffic Signal Hardware where:
a terminal compartment which mounts directly to a mast arm tenon;
the terminal compartment has two 1½″ NPT holes for attaching signal frameworks of different varieties:
the terminal compartment is made of sand-casting, brass, iron, or aluminum;
the door is made from cast aluminum and the castings are drilled and tapped to accept various types of hardware.

II: The Mast Arm Condulet (or MAC) assembly is a terminal compartment with a slip fitter on the side into which a tenon will fit. The slip fitter is drilled and tapped to accommodate three, ⅜″ set screws which are tightened to retain the MAC onto the tenon. There is also a slot cast through the slip fitter which is used for mounting a ⅜″ “safety bolt”.

III: A safety bolt inserted through the slot, a drilled hole in the tenon, and through the slot on the opposite side. The slot is used to retain the MAC assembly on the tenon in case of set screw failure.

IV: The main body according to claim I, has 2 raised bosses, drilled and tapped #10-32, to attach a terminal block. The opening is also drilled and tapped for two #10-32 screws for mounting the compartment door. The MAC main body has openings on the top and bottom which are tapped for 1½″ NPT pipe fittings. These holes are used to attach various length pipe nipples and fittings to accommodate different configurations of traffic signal lights and railroad lights.
